(19) United States
(12) Patent Application Publication
(10) Pub. No.: US 2006/0225083 A1
(43) Pub. Date: Oct. 5, 2006

(54) System and method for motion picture print forensics

(75) Inventor: Reza Rassool, Stevenson Ranch, CA (US)

Correspondence Address: DARBY & DARBY P.C., P. O. BOX 5257, NEW YORK, NY, 10150-5257, US

(73) Assignee: Widevine Technologies, Inc., Seattle, WA (US)

(21) Appl. No.: 11/352,799

(22) Filed: Feb. 13, 2006

Related U.S. Application Data
(60) Provisional application No. 60/657,843, filed on Mar. 1, 2005.

(51) Int. Cl. G06F 9/46

(52) U.S. Cl. 719/328; 283/113

(57) ABSTRACT

A system, apparatus, and method are directed towards managing motion picture film print marking and tracking using a reel changeover marking (RCM) to encode a unique identifier. In one embodiment, an Encoded RCM (ERCM) is located within a print during a print duplication process. The ERCM is arranged to persist through a variety of transformations, including camming, compression, and so forth. In one embodiment, an identification extraction component is configured to analyze a digital copy print to extract the unique identifier from within an ERCM. A print tracking component may then search a data store to determine a corresponding source print to the digital copy print based on the extracted unique identifier. A source of piracy may be determined, at least in part, by identifying possible security weaknesses in a distribution chain that may be associated with unauthorized duplication of the film print, and so forth.

### CROSS-REFERENCE TO RELATED APPLICATIONS

The present application claims priority from provisional application Ser. No. 60/657,843 entitled “System And Method For Motion Picture Print Forensics,” filed on Mar. 1, 2005, the benefit of the earlier filing date of which is hereby claimed under 35 U.S.C. § 119 (e), and further incorporated by reference.

### FIELD OF THE INVENTION

The present invention relates generally to copy protection and more particularly but not exclusively to enabling a marking of a duplicate print, such as a motion picture duplicate print, to enable traceable of pirated copies back to its original source print.

### BACKGROUND OF THE INVENTION

As domestic broadband communications spreads, so does such activities as the Internet piracy of entertainment content. Many businesses, such as the music industry, can now quantify the revenue losses due to piracy. The movie industry is also seeing the growth of piracy of theatrical releases on the Internet through a variety of technologies, including the use of peer-to-peer sharing networks, and so forth. Even though free sharing of files on the Internet is receiving visibility in the press, perhaps the more insidious multi-million dollar motion picture piracy may deserve increased attention. Therefore, it is with respect to these considerations and others that the present invention has been made.

### BRIEF DESCRIPTION OF THE DRAWINGS

Non-limiting and non-exhaustive embodiments of the present invention are described with reference to the following drawings. In the drawings, like reference numerals refer to like parts throughout the various figures unless otherwise specified.

For a better understanding of the present invention, reference will be made to the following Detailed Description of the Invention, which is to be read in association with the accompanying drawings, wherein:

FIG. 1 shows a functional block diagram illustrating one embodiment of an environment for practicing the invention;

FIG. 2 shows one embodiment of a server device that may be included in a system implementing the invention;

FIG. 3 illustrates functional diagrams generally showing one embodiment of possible examples of Reel Changeover Markings (RCMs) for use in practicing the invention;

FIG. 4 illustrates a logical flow diagram generally showing one embodiment of a process for managing motion picture film print marking; and

FIG. 5 illustrates a logical flow diagram generally showing one embodiment of a process for managing a duplicate print identification and tracking, in accordance with the present invention.

### DETAILED DESCRIPTION OF THE INVENTION

The present invention now will be described more fully hereinafter with reference to the accompanying drawings, which form a part hereof, and which show, by way of illustration, specific exemplary embodiments by which the invention may be practiced. This invention may, however, be embodied in many different forms and should not be construed as limited to the embodiments set forth herein; rather, these embodiments are provided so that this disclosure will be thorough and complete, and will fully convey the scope of the invention to those skilled in the art. Among other things, the present invention may be embodied as methods or devices. Accordingly, the present invention may take the form of an entirely hardware embodiment, an entirely software embodiment or an embodiment combining software and hardware aspects. The following detailed description is, therefore, not to be taken in a limiting sense.

Throughout the specification and claims, the following terms take the meanings explicitly associated herein, unless the context clearly dictates otherwise. The phrase “in one embodiment” as used herein does not necessarily refer to the same embodiment, though it may. The phrase “in another embodiment” as used herein does not necessarily refer to a different embodiment, although it may. Thus, it is apparent that various embodiments as described herein may be combined with other embodiments, without departing from the scope or the spirit of the invention.

In addition, as used herein, the term “or” is an inclusive “or” operator, and is equivalent to the term “and/or,” unless the context clearly dictates otherwise. The term “based on” is not exclusive and allows for being based on additional factors not described, unless the context clearly dictates otherwise. In addition, throughout the specification, the meaning of “a,” “an,” and “the” include plural references. The meaning of “in” includes “in” and “on.”

Briefly stated, the present invention is directed towards a system, apparatus, and method useable in managing motion picture film print marking and tracking. The invention employs a reel changeover marking (RCM) within a motion picture film print to encode a unique identifier. The unique identifier may be encoded onto each print using any of a variety of mechanisms. In one embodiment, an Encoded RCM (ERCM) is located within a print during a print duplication process. The ERCM is arranged to persist through a variety of transformations, including such activities as camming, compression, encoding, transcoding, frame-rate changing, color gamut changes, sizing, cropping, trapezoidal distortions, and so forth. Thus, the ERCM is useable to identify instances of digital copies of the print, including such instances that may arise due to piracy.

In one embodiment, an identification extraction component is configured to analyze a digital copy print and extract the unique identifier from within the ERCM. A print tracking component may then be employed to search a data store to determine the original source print from which the digital copy of the print was derived based on the extracted unique identifier. Use of the present invention is directed then to enable content owners, distributors, or the like, to determine a source of possible piracy by, at least in part, identifying possible security weaknesses in a distribution chain, theaters, or the like, that may have lesser print security; theaters, or the like, that may be associated with unauthorized duplication of a film print; and so forth.

Illustrative Environment

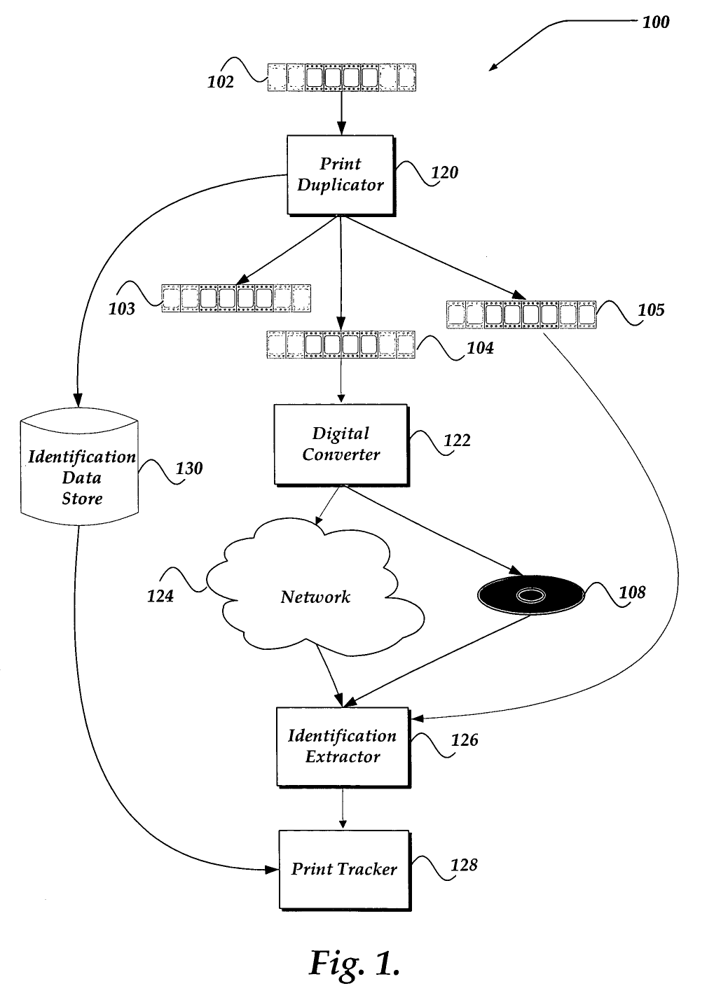

FIG. 1 shows a functional block diagram illustrating one embodiment of operating environment 100 in which the invention may be implemented. Operating environment 100 is only one example of a suitable operating environment and is not intended to suggest any limitation as to the scope of use or functionality of the present invention. Thus, other well-known environments and configurations may be employed without departing from the scope or spirit of the present invention.

As shown in the figure, system 100 includes original print 102, print duplicator 120, duplicate prints 103-105, digital converter 122, identification data store 130, network 124, digital medium 108, identification extractor 126, and print tracker 128.

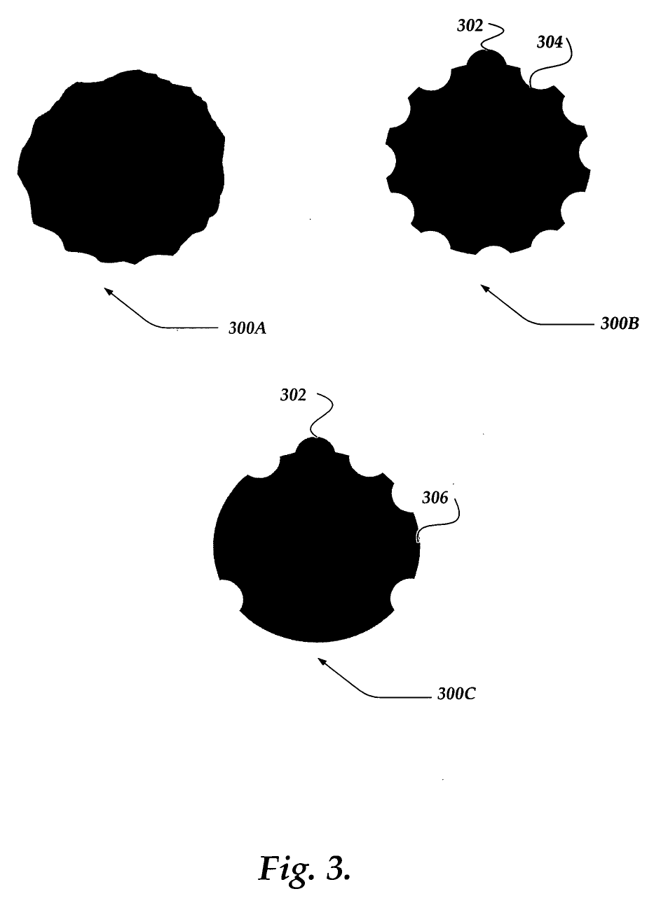

Original print 102 includes any content that may duplicated. Such original content may include movies, advertisements, music videos, music, or the like. In one embodiment, the original content represents a theatrical movie film. The original content may be provided for duplication from any of a variety of sources, including a content owner, content distributor, a content aggregator, or the like. Moreover, original print 102 may be formatted using any of a variety of formats, including 8 mm, 16 mm, and 35 mm prints, or the like. However, original print 102 is not constrained to these formats, and virtually any format may be employed. Such prints typically include one or more canisters of content, such that a showing of the content may include switching from a first content canister to a second content canister, and so forth. Changing of canisters may be identified by a presence of one or more Reel Changeover Marks (RCMs) described in more detail below in conjunction with FIG. 3.

Print duplicator 120 includes virtually any mechanism configured to receive original print 102 and to generate one or more copies, such as duplicate prints 103-105. Such copies may, for example, be distributed for use by film theaters, or the like.

Print duplicator 120 is further configured to determine a unique identifier associated with each duplicate print (copy) to be generated. The unique identifier may include virtually any information, including a serial number, an owner identifier associated with original print 102, an identifier associated with the content of original print 102, including, but not limited to a film title, creation date, a characteristic of an audio component and/or a video component of the content, or the like. Print duplicator 120 may provide the unique identifier, along with additional information to a data store, such as identification data store 130. Such additional information may include virtually any information that might be employable for use in tracking a duplicate print, including, but not limited to content addresses, a date of duplication, a date of creation, a location of duplication, an identifier associated with print duplicator 120, or the like.

Print duplicator 120 may encode the unique identifier onto at least some of duplicate prints 103-105, using a variety of mechanisms. In one embodiment, print duplicator 120 encodes the unique identifier in an RCM for duplicate prints 103-105. The encoded RCM (ERCM) may then be inserted onto at least some of duplicate prints 103-105. In one embodiment, the ERCM is inserted onto a visible portion of a frame within duplicate prints 103-105. The ERCM may be generated and inserted such that it persists through virtually any transformation that duplicate prints 103-105 may incur, including those that might occur during copying, including camming, compression, encoding, transcoding, frame-rate changes, color gamut changes, sizing, cropping, trapezoidal distortions, or the like.

Although print duplicator 120 is shown as encoding a unique identifier onto each of duplicate prints 103-105, the invention is not so constrained. For example, a unique identifier might be employed for a subset of duplicate prints. For example, a unique identifier might be used for those duplicate prints that might be considered for markets, and/or distribution chains where security might be a higher concern than other markets, and/or distribution chains, or the like.

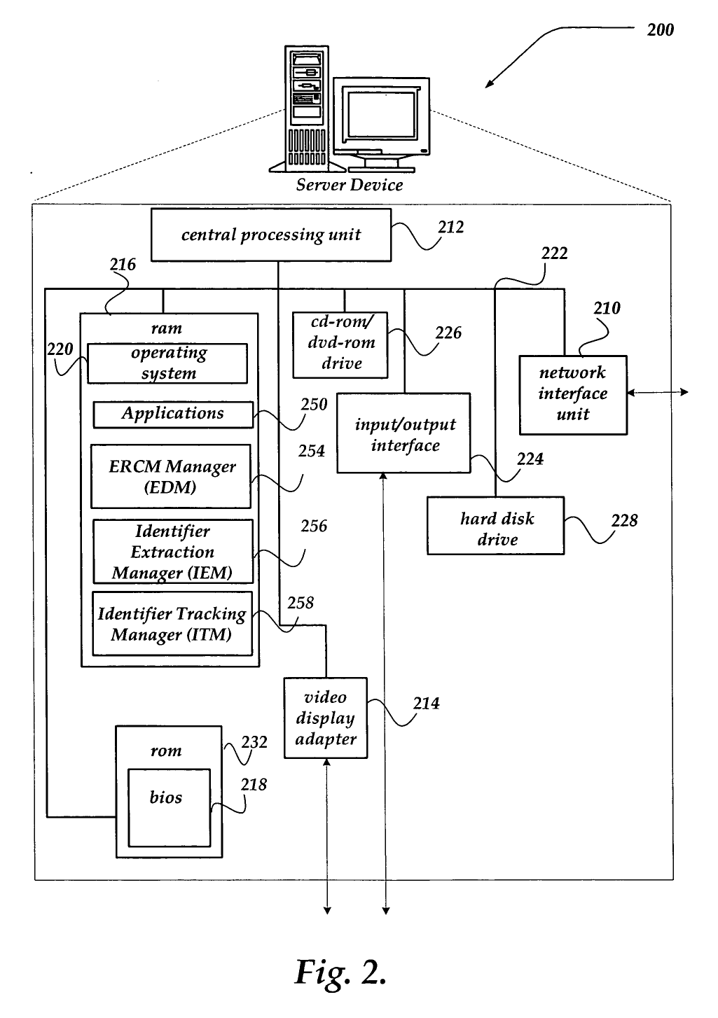

Devices that may operate as print duplicator 120 include film reproduction devices, personal computers, desktop computers, multiprocessor systems, microprocessor-based or programmable consumer electronics, network PCs, servers, or the like. Print duplicator 120 may also include additional components that are configured for inserting content, such as an ERCM onto a film print or the like. Such additional components may, for example, include film imprinters, film reproduction components, and so forth. One embodiment of print duplicator 120 employing a server device is illustrated below in conjunction with FIG. 2.

Although one embodiment of print duplicator 120 may employ a computing device, the invention is not so constrained. For example, the actions associated with print duplicator 120 may be implemented such that at least a portion of the actions are provided through a manual mechanism. For example, a manual record of unique identifiers may be managed for use in generating an ERCM. The generated ERCM may also be inserted manually onto at least some of duplicate prints 103-105. Thus, in one embodiment, print duplicator 120 may be implemented using a low technology mechanism for inserting the ERCM. For example, in one embodiment, the ERCM may be inserted manually onto at least one of duplicate prints 103-105 using a permanent marker pen, or the like.

Identification data store 130 may include virtually any mechanism that is configured to receive and manage the unique identifier, and any other additional information that may be employable for use in tracking a duplicate print. As such, identification data store 130 may include a folder, a database, a spreadsheet, a document, file, or the like. Moreover, identification data store 130 may be included within a computing device such as personal computers, desktop computers, multiprocessor systems, microprocessor-based or programmable consumer electronics, network PCs, servers, or the like.

Digital converter 122 represents virtually any mechanism for use in converting content on duplicate prints 103-105 into a digital format. For example, in one embodiment, digital converter 122 may represent an unauthorized conversion of a print, such as might arise due to piracy of a movie film, or the like. Moreover, such actions may arise due to unauthorized copying such as might arise by camming a theatrical presentation, controlled camming of a screening with a synchronized digital audio capture, or the like. Digital converter 122, however, is not constrained to unauthorized conversions. For example, digital converter 122 may also represent authorized conversions of duplicate prints 103-105 to a digital format, such as a Digital Versatile Discs (DVDs) for rental, or other portable content storage medium devices.

In any event, such conversions may also employ virtually any digital format. Audio content may be, for example, audio information such as music, speech, sound effects, or the like. Audio file formats currently popular and frequently encountered include ‘wave’ files (*.wav), MP3 files (*.mp3), liquid audio files (*.lqt), Real Audio™ (*.rm, *.ram), or the like. Image content may include still images and ‘moving’ images (hereafter referred to generally as ‘video’). Still image content may include, for example, textual files, photographs, drawings, paintings, trademarks, logos, designs, and so forth. Video content may also include, for example, computer files, which include computer code encodings of a series of images that may be viewed in rapid succession to create an illusion of motion. Video content formats may include MPEG (*.mpg) files, QuickTime (*.qt) files, Vivo (*.viv) files, Real Video™ (*.rm), and so forth. Some of these formats (Real Audio™ and Real Video™, for example) can be downloaded as streaming audio and/or video that is played in real-time. Other formats may be downloaded in part, or in their entirety, and stored locally for playing and/or for further redistribution at a future time after downloading. Thus, the digital content generated by digital converter 122 also may be provided over network 124 and/or provided on a digital medium, such as digital medium 108.

Digital medium 108 may include virtually any portable content storage medium configured to include digital content including, but not limited to Digital Versatile Discs (DVDs), High Definition DVD (HD-DVD), Compact Discs (CDs), Video Compact Disc (VCD), Super VCD (SVCD), Super Audio CD (SACD), Dynamic Digital Sound (DDS) content media, Read/Write DVD, CD-Recordable (CD-R), Blu-Ray discs, or the like.

Devices that may operate as digital converter 122 include but are not limited to digital cameras, digital video recorders, scanners, personal computers, desktop computers, multiprocessor systems, servers, and similar telecine and/or telesync devices.

Network 124 is configured to couple one computing device with another computing device. Network 124 may be enabled to employ any form of computer readable media for communicating information from one electronic device to another. Also, network 124 can include the Internet in addition to local area networks (LANs), wide area networks (WANs), direct connections, such as through a universal serial bus (USB) port, other forms of computer-readable media, or any combination thereof. On an interconnected set of LANs, including those based on differing architectures and protocols, a router acts as a link between LANs, enabling messages to be sent from one to another. Also, communication links within LANs typically include twisted wire pair or coaxial cable, while communication links between networks may utilize analog telephone lines, full or fractional dedicated digital lines including T1, T2, T3, and T4, Integrated Services Digital Networks (ISDNs), Digital Subscriber Lines (DSLs), wireless links including satellite links, or other communications links known to those skilled in the art. Furthermore, remote computers and other related electronic devices could be remotely connected to either LANs or WANs via a modem and temporary telephone link.

Network 124 may further include any of a variety of wireless sub-networks that may further overlay stand-alone ad-hoc networks, and the like, to provide an infrastructure-oriented connection. Such sub-networks may include mesh networks, Wireless LAN (WLAN) networks, cellular networks, and the like. Network 124 may also include an autonomous system of terminals, gateways, routers, and the like connected by wireless radio links, and the like. These connectors may be configured to move freely and randomly and organize themselves arbitrarily, such that the topology of network 124 may change rapidly.

Network 124 may further employ a plurality of access technologies including 2nd (2G), 2.5, 3rd (3G), 4th (4G) generation radio access for cellular systems, WLAN, Wireless Router (WR) mesh, and the like. Access technologies such as 2G, 3G, and future access networks may enable wide area coverage for mobile devices with various degrees of mobility. For example, network 124 may enable a radio connection through a radio network access such as Global System for Mobile communication (GSM), General Packet Radio Services (GPRS), Enhanced Data GSM Environment (EDGE), Wideband Code Division Multiple Access (WCDMA), CDMA2000, or the like. In essence, network 124 may include virtually any wired and/or wireless communication mechanisms by which information may travel between one computing device and another computing device, network, aor the like.

Additionally, communication media typically embodies computer-readable instructions, data structures, program modules, or other data in a modulated data signal such as a carrier wave, data signal, or other transport mechanism and includes any information delivery media. The terms “modulated data signal,” and “carrier-wave signal” includes a signal that has one or more of its characteristics set or changed in such a manner as to encode information, instructions, data, and the like, in the signal. By way of example, communication media includes wired media such as twisted pair, coaxial cable, fiber optics, wave guides, and other wired media and wireless media such as acoustic, RF, infrared, and other wireless media.

Identification extractor 126 is configured to receive a duplicate print, in digital format, such as from digital converter 122, or the like. Identification extractor 126 may also be configured to receive a duplicate print, such as duplicate prints 103-105. Identification extractor 126 may employ any of a variety of mechanisms to extract the unique identifier from the received duplicate print. Identification extractor 126 may then provide the unique identifier to print tracker 128.

Print tracker 128 includes virtually any device that is configured to receive the unique identifier and to search identification data store 130 for a match. If a match is located, print tracker 128 may provide a report, a message, or the like, that includes information employable in tracking the associated duplicate print, including a source owner, where the associated original content was made available, when the original content was made available, or the like.

Devices that may operate as identification extractor 126, and/or print tracker 128 include personal computers, desktop computers, multiprocessor systems, microprocessor-based or programmable consumer electronics, network PCs, servers, or the like. Moreover, although identification extractor 126 and print tracker 128 are illustrated as distinct devices, the invention is not so constrained. For example, identification extractor 126 and print tracker 128 may be within a single device, or distributed across multiple devices. Moreover, identification data store 130 may be included within print duplicator 120, included within another computing device, or the like.

Illustrative Server Environment

FIG. 2 shows one embodiment of a server device, according to one embodiment of the invention. Server device 200 may include many more components than those shown. The components shown, however, are sufficient to disclose an illustrative embodiment for practicing the invention. Server device 200 may, for example, print duplicator 120 of FIG. 1. Server 200 may further be employed to manage such other activities as described above for identification extractor 126, and/or print tracker 128 of FIG. 1 by including appropriate additional components.

Server device 200 includes processing unit 212, video display adapter 214, and a mass memory, all in communication with each other via bus 222. The mass memory generally includes RAM 216, ROM 232, and one or more permanent mass storage devices, such as hard disk drive 228, tape drive, optical drive, and/or floppy disk drive. The mass memory stores operating system 220 for controlling the operation of server device 200. Any general-purpose operating system may be employed. Basic input/output system (“BIOS”) 218 is also provided for controlling the low-level operation of server device 200. As illustrated in FIG. 2, server device 200 also can communicate with the Internet, or some other communications network, such as network 124 in FIG. 1, via network interface unit 210, which is constructed for use with various communication protocols including the TCP/IP protocol. Network interface unit 210 is sometimes known as a transceiver, transceiving device, network interface card (NIC), or the like.

Server device 200 may also include an SMTP handler application for transmitting and receiving email. Server device 200 may also include an HTTP handler application for receiving and handing HTTP requests, and an HTTPS handler application for handling secure connections. The HTTPS handler application may initiate communication with an external application in a secure fashion.

Server device 200 also includes input/output interface 224 for communicating with external devices, such as a mouse, keyboard, scanner, or other input devices not shown in FIG. 2. For example, input/output interface 224 may be employed to provide output information to another device, such as a film imprinter, film duplication component or the like. Input/output interface 224 may also be configured to provide an ERCM to a pen mechanism, or the like, for inserting the ERCM onto a duplicate print. Input/output interface 224 may also receive input information from such devices as a scanner, camera, a telecine, and/or telesync device, or so forth.

Server device 200 may further include additional mass storage facilities such as CD-ROM/DVD-ROM drive 226 and hard disk drive 228. Hard disk drive 228 is utilized by server device 200 to store, among other things, application programs, databases, or the like.

The mass memory as described above illustrates another type of computer-readable media, namely computer storage media. Computer storage media may include volatile, nonvolatile, removable, and non-removable media implemented in any method or technology for storage of information, such as computer readable instructions, data structures, program modules, or other data. Examples of computer storage media include RAM, ROM, EEPROM, flash memory or other memory technology, CD-ROM, digital versatile disks (DVD) or other optical storage, magnetic cassettes, magnetic tape, magnetic disk storage or other magnetic storage devices, or any other medium which can be used to store the desired information and which can be accessed by a computing device.

The mass memory also stores program code and data. One or more applications 250 are loaded into mass memory and run on operating system 220. Examples of application programs include email programs, schedulers, calendars, transcoders, database programs, word processing programs, spreadsheet programs, and so forth. Mass storage may further include applications such as ERCM Manager (EDM) 254, Identifier Extraction Manager (IDM) 256, and Identifier Tracking Manager (ITM) 258. EDM 254, IDM 256, and ITM 258 are illustrated in server device 200 for completeness sake. However, EDM 254, IDM 256, and ITM 258 may also be in distinct server devices. For example, one server device may include EDM 254, while another server device includes IDM 256 and/or ITM 258, without departing from the scope or spirit of the present invention.

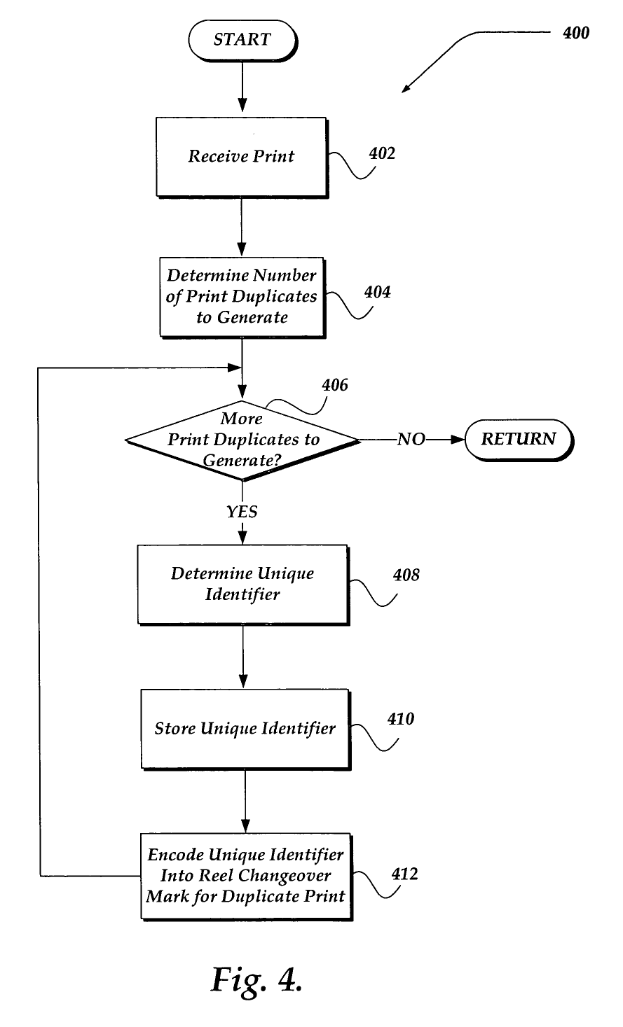

EDM 254 is configured to determine a unique identifier associated with a duplicate print and to enable the encoding of the unique identifier into a RCM to generate an encoded RCM (ERCM). The unique identifier may include virtually any information, such as that described above. In one embodiment, the unique identifier is represented by a number of bits or marks. Moreover, the unique identifier may comprise any number of bits to describe the information. For example, in one embodiment, an 11-bit unique identifier may be employed to encode about 2048 duplicate prints. Thus, in one embodiment, each duplicate print may include a different unique identifier. EDM 254 may further provide the unique identifier to a data store, such as identification data store 130 of FIG. 1, to enable accessibility of the unique identifier for tracking of the duplicate print(s). EDM 254 may provide the ERCM to input/output interface 224 for imprinting the ERCM onto a print. For example, EDM 254 may direct a mechanical pen device to insert the ERCM onto a duplicate print. EDM 254 may further employ a process substantially similar to process 400 of FIG. 4 to perform its actions. Again, although illustrated within a computing device, EDM 254, some or all of its actions may be implemented employing manual mechanisms, without departing from the scope or spirit of the invention.

IEM 256 is configured to receive an ERCM and to extract the unique identifier. In one embodiment, IEM 256 receives a digital duplicate print and extracts the unique identifier from the ERCM based, in part, on knowledge about the encoding mechanism employed. In another embodiment, IEM 256 may receive a print film, such as duplicate prints 103-105. IEM 256 or another component (not shown) may convert the print film, or a portion of the print film, to a digital format, such that the unique identifier may be extracted. In addition, such encoding mechanisms may include, for example, those described below in conjunction with FIG. 3. IEM 256 is further configured to provide the unique identifier to another component, such as ITM 258.

ITM 258 is configured to receive the unique identifier and to perform a search for a match in a data store, such as identification data store 130 of FIG. 1. ITM 258 may then provide information, a message, or the like, that may be employable in tracking a print. For example, ITM 258 may provide such information as an owner of the content, a designated distributor of a duplicate print, where and/or when content is released, or the like. In one embodiment, the information may be provided to a content owner.

FIG. 3 illustrates functional diagrams generally showing one embodiment of possible examples of Reel Changeover Markings (RCMs) for use in practicing the invention. As shown in the figure, RCM 300A represents one embodiment of a typical Reel Changeover Mark, while ECRM 300B and 300C illustrate embodiments of Reel Changeover Marks encoded with identifiers. Marking of a print need not employ high technology equipment or processes to enable tracking of a print, although such may be employed. In the present invention, Reel Changeover Marks are employed to ‘carry’ the unique identifier.

Briefly, an RCM typically appears as a single “dot” on a print over multiple frames. RCMs may appear twice or more in each reel associated with a print, over the multiple frames. The first mark typically appears about a minute before the end of the reel and the second typically appears near the end of the reel, although the invention is not constrained to its location, or timing of occurrence.

The marks, typically in the upper right hand corner of the frame, often approximately circular or even oval in shape, which appear at the end of each reel of the projected print (except perhaps the last reel), are intended to provide a cue to a projectionist that a reel change is imminent. This allows a fluid change from one projector to another. At most commercial theaters today, the reels are built onto a large platter, making changeover marks virtually unnecessary. However, the RCM is still part of the print duplication process to maintain a backward compatibility for older theaters.

The RCM may be applied with a ‘pen,’ manually or automatically. A blocking chemical may be further stamped onto the print to appear as a white oval when projected. One example of an RCM is illustrated in FIG. 3 as RCM 300A. As is shown in the figure, RCM 300A is typically approximately circular in shape. A chemical blocker which may be included tends to bleed at the edges of the shape causing the approximately circular shape to acquire a more ragged edge appearance. A projection lens may also cause the circle to be projected as an oval, however.

The present invention encodes a unique identifier into the application of the RCM to the print. In a typical print, there are two changeover marks per reel. Therefore, it may be possible to increase an address range to virtually any number of bits associated with the encoding of the unique identifier. For example, employing 22 bits might enable about 4 million prints to be uniquely addressed. Furthermore, while a variety of information may be encoded, an RCM need not encode any other information than a unique identifier to label a print.

As shown in FIG. 3, ERCM 300B illustrates one embodiment of encoding an identifier. ERCM 300B includes small bump 302 at about zero degrees (near an approximate upper position on ERCM 300B), which may be employed as an orientation marker for use in indicating a starting location for encoding the unique identifier. Chip 304 indicates a portion of ERCM 300B that has been ‘removed’ to indicate an encoded bit. As shown in ERCM 300B multiple clockwise positions are removed thereby encoding, for one embodiment, zeros. Positions around ERCM 300B may be selectively filled to indicate a one. However, the invention is not constrained to this interpretation. For example, filled positions could represent zeros and removed positions could represent ones. Moreover, the orientation marker, may also be located at virtually any other position around ERCM 300B, including, for example, at approximately a three o'clock position, a five o'clock position, or the like.

As shown in ERCM 300C, several removed positions are filled in, such as filled position 306. As illustrated ERCM 300C represents one embodiment for encoding the bit string “10010001011,” or 1163 in decimal.

The height of bump 302, a depth of a removed position, or the like, may be modified to enable ready decoding/encoding without deviating too much from a typical ragged circle (e.g., RCM 300A). This minimizes ready detection of the encoded unique identifier.

Although the above examples, illustrate removed portions and filled portions to encode the unique identifier, the invention is not constrained to just these examples. For example, particular shapes, patterns, or the like, may also be used to encode the unique identifier, without departing from the scope or spirit of the present invention. For example, various triangular patterns may be employed to modify RCM 300A.

Generalized Operation

The operation of certain aspects of the invention will now be described with respect to FIG. 4. FIG. 4 illustrates a logical flow diagram generally showing one embodiment of a process for managing motion picture film print marking.

Process 400 of FIG. 4 begins, after a start block, at block 402 when a film print is received. Additional information associated with the film print may also be received. For example, information about how many duplicates are to be produced, whether selected duplicates are to be encoded with unique identifiers, an owner of the received film print, destination(s) of the duplicates, or the like. Processing flows next 404 where the additional information may be employed to configure a component, such as a film duplication component, for the number of duplicates to be produced. Processing continues to decision block 406, where a determination is made whether the requested number of duplicated have been generated. If so, processing returns to a calling process to perform other actions; otherwise, if there are more duplicate prints to generate, processing flows to block 408.

At block 408, a unique identifier is determined for the duplicate print. The unique identifier may include virtually any information including a sequencing number, a number based, at least in part, on the received film print, on an owner identifier, a destination, or the like. Processing then flows to block 410, where the unique identifier is stored. In one embodiment, the unique identifier is stored in a database that is accessible to a downstream print tracking component.

Processing flows next to block 412, where the unique identifier is encoded into a reel changeover mark and inserted onto the associated duplicate print. The unique identifier may be encoded using virtually any encoding scheme, including that which is described above in conjunction with FIG. 3. Process 400 then loops back to decision block 406, to continue until there are no more duplicate prints to generate.

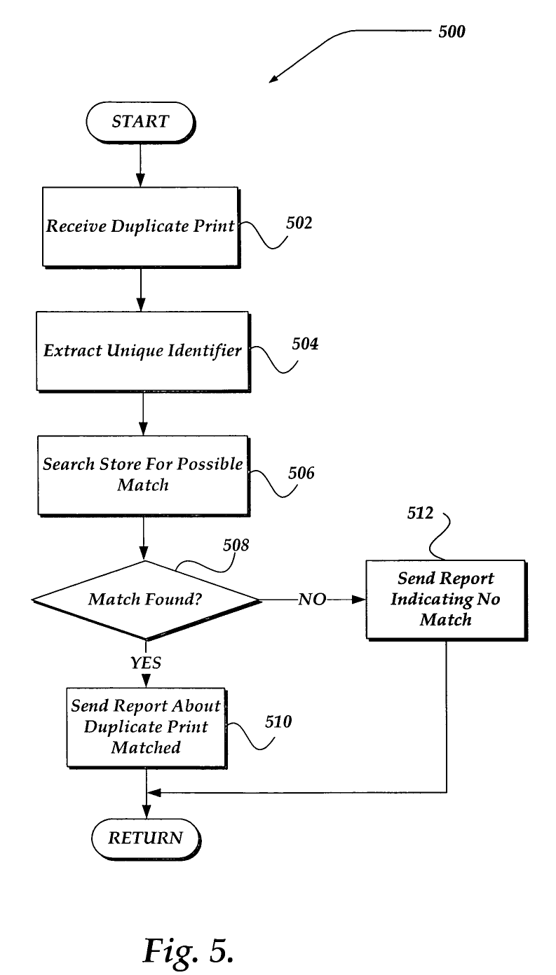

FIG. 5 illustrates a logical flow diagram generally showing one embodiment of a process for managing a duplicate print identification and tracking. Process 500 of FIG. 5 may be implemented, for example, across identification extractor 126 and print tracker 128 of FIG. 1.

Process 500 begins, after a start block, at block 502, where a duplicate print is received. In one embodiment, the duplicate print is a digital duplicate of a duplicate print generated employing a process substantially similar to process 400 described above. Process 500 flows next to block 504 where the unique identifier is digitally extracted from within an encoded reel changeover mark within the digital duplicate print. Processing continues to block 506, where a data store is searched for a possible match on the extracted unique identifier.

Continuing to decision block 508, a determination is made whether a match is found in the data store for the extracted unique identifier. If no match is found, processing continues to block 512, where a report is sent indicating that non match is found. No match may be found for any of a variety of reasons, including the data store is not current, the encoded reel changeover mark was significantly altered such that the unique identifier extracted is not correct, or the like. Processing then returns to a calling process to perform other actions.

If it is determined that a match is found, however, at decision block 508, processing continues to block 510, where additional information may be obtained from the data store, such that a report may be generated. The generated report may include for example, owner information, destination information, distribution chain information, or the like. Processing then returns to the calling process to perform other actions.

It will be understood that each block of the flowchart illustration, and combinations of blocks in the flowchart illustration, can be implemented by computer program instructions. These program instructions may be provided to a processor to produce a machine, such that the instructions, which execute on the processor, create means for implementing the actions specified in the flowchart block or blocks. The computer program instructions may be executed by a processor to cause a series of operational steps to be performed by the processor to produce a computer implemented process such that the instructions, which execute on the processor to provide steps for implementing the actions specified in the flowchart block or blocks.

Accordingly, blocks of the flowchart illustration support combinations of means for performing the specified actions, combinations of steps for performing the specified actions and program instruction means for performing the specified actions. It will also be understood that each block of the flowchart illustration, and combinations of blocks in the flowchart illustration, can be implemented by special purpose hardware-based systems which perform the specified actions or steps, or combinations of special purpose hardware and computer instructions. Moreover, at least some of the blocks of the flowchart illustration, and combinations of some of the blocks in the flowchart illustration, can also be implemented using a manual mechanism, without departing from the scope or spirit of the invention.

The above specification, examples, and data provide a complete description of the manufacture and use of the composition of the invention. Since many embodiments of the invention can be made without departing from the spirit and scope of the invention, the invention resides in the claims hereinafter appended.

What is claimed as new and desired to be protected by Letters Patent of the United States is:

1. An apparatus useable in managing print duplications, comprising:
a processor; and
a memory in communication with the processor and for use in storing data and machine instructions that cause the processor to perform a plurality of operations, including:
receiving a print, wherein the print comprises a media film print;
determining a unique identifier associated with at least a duplicate of the print;
encoding the unique identifier into a reel changeover mark (RCM) within the duplicate of the print.

2. The apparatus of claim 1, further comprising:
providing the unique identifier to a data store such that the unique identifier is available for use in tracking the duplicate of the print.

3. The apparatus of claim 1, wherein determining a unique identifier associated with a duplicate of the print further comprises determining the unique identifier based on at least one of a serial number, an owner associated with the print, an identifier associated with the media film of the print, a characteristic of an audio component of the print, a characteristic of a video component of the print, or a date of duplication of the print.

4. The apparatus of claim 1, wherein the encoded RCM is inserted onto a visible portion of a frame associated with the duplicate of the print.

5. The apparatus of claim 1, wherein encoding the unique identifier into the RCM further comprises:
determining an orientation marker for encoding the unique identifier into the RCM; and
encoding the unique identifier as a bit representation around a circumference of the RCM.

6. The apparatus of claim 5, wherein encoding the bit representation further comprises at least one of removing a portion of the RCM to encode a bit representation or adding a mark to a portion of the RCM to encode a bit representation.

7. The apparatus of claim 1, wherein the encoding of the unique identifier further comprises encoding a digital representation of the unique identifier into the RCM.

8. The apparatus of claim 1, the operations further comprising:
receiving the duplicate of the print with the encoded RCM;
extracting the unique identifier from within the encoded RCM;
searching a data store for a match on the unique identifier; and
providing a report based, in part, on a result of the search, the report being useable for determining a security status of a distribution chain associated with the duplicate of the print.

9. A method of managing content print duplication, comprising:
receiving a print, wherein the print comprises a film print;
determining a unique identifier associated with a duplicate of the print;
encoding the unique identifier into a reel changeover mark (RCM); and
inserting the encoded RCM onto the duplicate of the print.

10. The method of claim 9, wherein encoding the unique identifier into the RCM further comprises: modifying a physical appearance of the RCM by encoding the unique identifier into the RCM.

11. The method of claim 9, wherein encoding the unique identifier further comprises removing portions or filling portions of the RCM.

12. The method of claim 9, wherein encoding the unique identifier further comprises identifying an orientation marker for encoding the unique identifier into the RCM.

13. The method of claim 9, further comprising:
receiving a digitally converted copy of the duplicate of the print with the encoded RCM;
extracting the unique identifier from the encoded RCM;
searching a data store for a match on the extracted unique identifier; and
providing a report based, in part, on a result of the search.

14. A modulated data signal configured to include program instructions for performing the method of claim 9.

15. A system of managing content print duplication, comprising:
a print duplicator that is operative to perform actions, including:
receiving a print, wherein the print comprises a film print;
determining a unique identifier associated with a duplicate of the print;
encoding the unique identifier into a reel changeover mark (RCM); and
inserting the encoded RCM onto the duplicate of the print; and
an identification extractor that is operative to perform actions, including:
receiving the duplicate of the print with the encoded RCM; and
extracting the unique identifier from the encoded RCM.

16. The system of claim 15, wherein receiving the duplicate of the print further comprises receiving a digitally converted copy of the duplicate of the print with the encoded RCM.

17. The system of claim 16, wherein extracting the unique identifier further comprises extracting the unique identifier from the digitally converted copy of the duplicate of the print.

18. The system of claim 15, further comprising:
a print tracker that is operative to perform actions, including:
searching a data store for a match on the extracted unique identifier; and
providing a report based, in part, on a result of the search.

19. The system of claim 15, wherein encoding the unique identifier physically modifies an appearance of the RCM.

20. The system of claim 15, wherein the encoding is arranged into the RCM to be persistent through at least one of camming, compression, encoding, transcoding, frame-rate changing, color gamut changes, sizing, cropping, or a trapezoidal distortion of at least a portion of the duplicate of the print.

21. The system of claim 15, wherein the unique identifier is useable to detect a security weakness in a print distribution chain.

22. A device that is useable to manage content print duplication, comprising:
a transceiver to receive the content print;
means for determining a unique identifier associated with a content print duplicate;
means for duplicating the content print;
means for encoding the unique identifier into a mark; and
means for inserting the encoded mark onto the content print duplicate.
